(19) United States
(12) Patent Application Publication
(10) Pub. No.: US 2004/0200528 A1
(43) Pub. Date: Oct. 14, 2004

(54) Pressure reducer with dirt trap

(76) Inventor: Willi Hecking, Wohnsitz (DE)

Correspondence Address: Law Offices Mallinckrodt & Mallinckrodt, Suite 510, 10 Exchange Place, Salt Lake City, UT, 84111, US

(21) Appl. No.: 10/817,180

(22) Filed: Apr. 1, 2004

(30) Foreign Application Priority Data
Apr. 8, 2003 (DE) 103 16 274.7

(51) Int. Cl. G05D 16/04

(52) U.S. Cl. 137/239

(57) ABSTRACT

In a pressure reducer with an inlet pressure chamber with a cylindrical dirt trap dividing the inlet pressure chamber into an inlet-side sub-chamber and a control valve-side sub-chamber, there are backflow means (74) for generating a backflow through the dirt trap from the control valve-side sub-chamber provided within the inlet-side sub-chamber adjacent to the dirt trap. Such backflow means are provided with an annular body with an annular chamber, wherein the annular body is on the outside sealingly guided in a housing of the pressure reducer by two spaced apart sealing rings which surround the dirt trap. The annular body is provided with axially projecting sucking ribs adjacent to the dirt trap and open towards the dirt trap which are connected to the annular chamnber of the annular body. The annular body is rotatable about the dirt trap. The annular chamber can be connected to an outlet by a stop valve.

### BACKGROUND OF THE INVENTION

1. Field

The invention relates to a pressure reducer with an inlet pressure chamber with a cylindrical dirt trap dividing the inlet pressure chamber into an inlet-side sub-chamber and a control valve-side sub-chamber, wherein backflow means for generating a backflow through the dirt trap from the control valve-side sub-chamber are provided within the inlet-side sub-chamber adjacent to the dirt trap.

2. State of the Art

It is the function of a pressure reducer to maintain the water pressure, for example in a house water system, at a given value, even if the pressure from the supply pipe is higher. For this purpose a pressure reducer is provided with a spring biased control diaphragm closing a control pressure chamber. The control diaphragm is connected to a valve tappet extending through the valve passage of a valve seat and carrying a valve closing member at its end in an outlet pressure chamber. An inlet pressure chamber with the pressure of the supply pipe is formed upstream of the valve seat. Downstream of the valve seat there is a controllable outlet pressure. This outlet pressure is transferred to the control pressure chamber. If the outlet pressure increases beyond a value given by the spring bias of the control diaphragm, the diaphragm, due to the effect of the outlet pressure, moves against the spring bias. The valve tappet moves the valve closing member towards the valve seat, whereby the valve passage is narrowed and the outlet pressure decreases to the desired value.

A known pressure reducer is an integral assembly which can be inserted into the housing of the fitting in one piece. The housing of the fitting is provided with an inlet socket and an outlet socket for installing the housing of the fitting in the water pipe. The inlet connection is connected to the inlet pressure chamber and the outlet pressure chamber is connected to the outlet socket. The pressure reducer assembly comprises a pressure reducer “bottom part,” and a pressure reducer “top part.” The pressure reducer bottom part is of cup-like tapering shape and closed by the control diaphragm. The pressure reducer top part is provided with an annular first portion screwed to the pressure reducer bottom part. The first portion is connected to a second annular portion by webs forming a valve passage and a valve seat. A valve tappet is connected to the control diaphragm extending coaxially to the pressure reducer bottom and top parts through the valve passage and carries the valve closing member at its end. A clamping ring lies on the pressure reducer bottom part clamping the edges of the diaphragm. A cap-shaped spring housing is placed on the clamping ring, a bias spring with means for adjusting the spring bias being arranged therein. A plastic cap engages with a rim projecting towards the inside around a projecting rim of the spring housing. The spring cap is screwed to the housing of the fitting and holds the assembly adjacent to the housing of the fitting.

An inlet pressure chamber is formed within the plastic cap, the valve tappet centrally extending therethrough. The housing of the fitting fonns an outlet pressure chamber. A passage extending throught the valve closing body and the valve tappet connects the outlet pressure chamber with the control pressure chamber.

A dirt trap is provided in order to avoid failure of the ftmction of the pressure reducer by dirt particles in water. Such a dirt trap is a cylindrical sieve or filter held between the first and the second portion of the pressure reducer top part coaxially with the valve tappet. This dirt trap divides the inlet pressure chamber into an inlet-side and a control valve-side sub-chamber.

It is necessary to clean this dirt trap in regular intervals. For this purpose the pressure reducer assembly according to the prior art is dismantled after the connection to the supply pipe has been blocked.

From DE 37 14 660 A1 a filter fitting with a pressure reducer is known. The filter fitting comprises a cylindrical filter and a cylindrical sucking device abutting the inlet-side surface of the filter with limited sucking openings and connectable to an outlet through an outlet valve. For moving the sucking device over the surface of the filter an axially moveable actuating member is provided which is exposed to the inlet pressure on one side and, on its other side, limits a chamber which is connected to the inlet through the sucking device acting as a restrictor and which is closed by the outlet valve. When the outlet valve is opened a pressure difference across the actuating member and the sucking device is generated. Thereby the actuating member carries out an axial stroke. The sucking device is positioned at the actuating member in such a way that it moves in a longitudinal direction axially over the surface of the filter.

In DE 37 14 660 A1 a pressure reducer with a control diaphragm fixed in a housing and spring biased is arranged within the filter. The filter fitting is provided with two coaxial, tubular sockets, which form an annular space therebetween. The annular space is connected to the inlet and forms an inlet pressure chamber. The inner socket carries a valve seat body with a valve seat forming the valve passage of the pressure reducer control valve. The pressure reducer is coaxially mounted in a housing within a filter cup. The pressure reducer has a control valve connected to the control diaphragm through the valve tappet co-operating with the valve seat and controlling the connection between the inner space of the filter and the outlet. The control diaphragm limits the control pressure chamber. The control pressure chamber is connected to the outlet by a passage extending through the valve closing body of the control valve and the valve tappet. The filter is held between a flange of the inner tubular socket and a flange at the housing of the pressure reducer and practically completely surrounds the housing.

The cylindrical filter divides the inlet pressure chamber in an inlet-side and a control valve-side sub-chamber as a dirt trap.

The known construction is large and expensive.

DE 197 35 893 A1 describes a filter fitting for drinking water with a pressure reducer and a filter arranged on the inlet side of the pressure reducer. The filter is cylindrical and provided with a sucking device guided axially through the filter. The pressure reducer is arranged outside of the filter and laterally to the axis of the filter in the housing. The assembly formed by the filter fitting and the pressure reducer is connected to a manifold with a plurality of connections and a switching valve positioned between the manifold and the assembly. Flow paths can be established either between the connection of the manifold, as an inlet, through the filter only or serially from the filter and pressure reducer to a further connection, as an outlet.

### SUMMARY OF THE INVENTION

It is an object of the invention to constructively simplify a pressure reducer of the above mentioned kind.

This object is achieved in that the backflow means cover limited angular ranges of the dirt trap and are rotatable about the axis of the dirt trap for covering the entire circumference of the dirt trap.

The backflow means cover only a limited angular range. Between such angular ranges, the dirt trap in operation is free, so that the water can enter the control valve-side sub-chamber through the dirt trap. For sucking-off the entire dirt trap the backflow means are rotated about the axis of the dirt trap. The entire surface of the dirt trap can be consecutively covered. If, for example, the backflow means cover four angular ranges which are offset by 90° and which may be relatively small, a 90° turn of the backflow means is sufficient to cover the entire surface of the dirt trap. Rotation of the backflow means beyond a limited range is constructively easier to handle than a longitudinal shift of annular backflow means over the entire height of the dirt trap.

A particularly advantageous construction is characterised in that the backflow means are provided with an annular body with an annular chamber, wherein the annular body is, on its outside, sealingly guided in a housing of the pressure reducer by two spaced apart sealing rings which surround the dirt trap, the annular body is provided with an axially projecting sucking ribs adjacent to the dirt trap and open towards the dirt trap which are connected to the annular chamber of the annular body, the annular body is rotatable about the dirt trap and means are provided for generating, in the annular chamber, a pressure reduced with respect to the inlet pressure.

In this case there are free areas between the sucking rib areas of the dirt trap, through which the water can flow through the dirt trap towards the control valve of the pressure reducer. The reduced pressure is generated in the annular chamber. By rotating the annular body the sucking ribs are guided along the circumference over the dirt trap.

The reduced pressure can be generated in the annular chamber by providing a circumferential slot in the housing around the annular body, the slot extending through an angular range, which is sealed against the annular body by sealing rings which, on both sides of the circumferential slot, abut to the housing, guiding an outlet pipe through the slot into the annular chamber and positioning a stop valve in the outlet line.

In this case atmospheric pressure in the annular chamber is generated by opening of the stop valve. Inside the dirt trap is inlet pressure. Thereby a back flow is generated from the inlet chamber through the dirt trap, through the sucking ribs and through the outlet controlled by the stop valve. Dirt particles held back by the outside of the dirt trap are carried away by the back flow and discharged. A firther advantage by this configuration is that the stop valve projecting from the housing also forms a handle leading out of the housing by which the annular body with the sucking ribs can be manually rotated about the axis of the cylindrical dirt trap.

The sucking ribs are arranged around the dirt trap with small tolerance. Coarse dirt particles cannot directly be sucked off by contact with the sucking ribs dirt trap. They would be wiped off by the sucking ribs on their outside when the backflow means are rotated and would sink downwards onto the pressure reducer top part due to the influence of gravity. With the circumferential movement of the annular body such particles would be moved back and forth by the sucking ribs without entering the sucking ribs and without being discharged. Therefore, it is advantageous that the sucking ribs are open axially downwards, and a ring of axial blind holes is formed there around the dirt trap. In such a way the dropped larger particles are shifted into such blind holes by the sucking ribs when rotating. If then the sucking ribs pass over the sack holes with their lower openings the particles are sucked in and carried away.

The invention particularly advantageously can be used with a pressure reducer wherein a cup-shaped pressure reducer bottom part is closed by a spring biased control diaphragm and forms a control pressure chamber exposed to the outlet pressure, a pressure reducer top part in alignment therewith is provided with a first annular portion, which is attached to the pressure reducer bottom part and which is connected to a second annular portion by webs, the second annular portion forming a valve seat of a control valve with a valve passage, a valve tappet is connected to the control diaphragm, the valve tappet extending through the control pressure chamber, the pressure reducer bottom part and the valve passage and carrying a valve closing member forming the control valve together with the valve seat, and the dirt trap is held coaxial to the valve tappet between the first annular portion and the second annular portion. Advantageously a spring housing containing the biasing spring, the pressure reducer bottom part and the pressure reducer top part are tightened by tightening the control diaphragm against the housing of the fitting with a fixing cap screwed to the housing of the fitting, the inlet pressure chamber being within the fixing cap, and the slot for the outlet pipe is formed within the fixing cap.

This is a very compact assembly of a pressure reducer with backflow.

An embodiment of the invention is described hereinbelow in greater detail with reference to the accompanying drawings.

### BRIEF DESCRIPTION OF THE DRAWINGS

FIG. 1 shows a longitudinal section of a pressure reducer wherein cleaning of the dirt trap is achieved by back flow.

FIG. 2 shows a detail XY of FIG. 1.

FIG. 3 is a perspective view of the backflow device of the pressure reducer of FIG. 1.

FIG. 4 shows a cross section of the backflow device of FIG. 3.

### DESCRIPTION OF PREFERRED EMBODIMENT

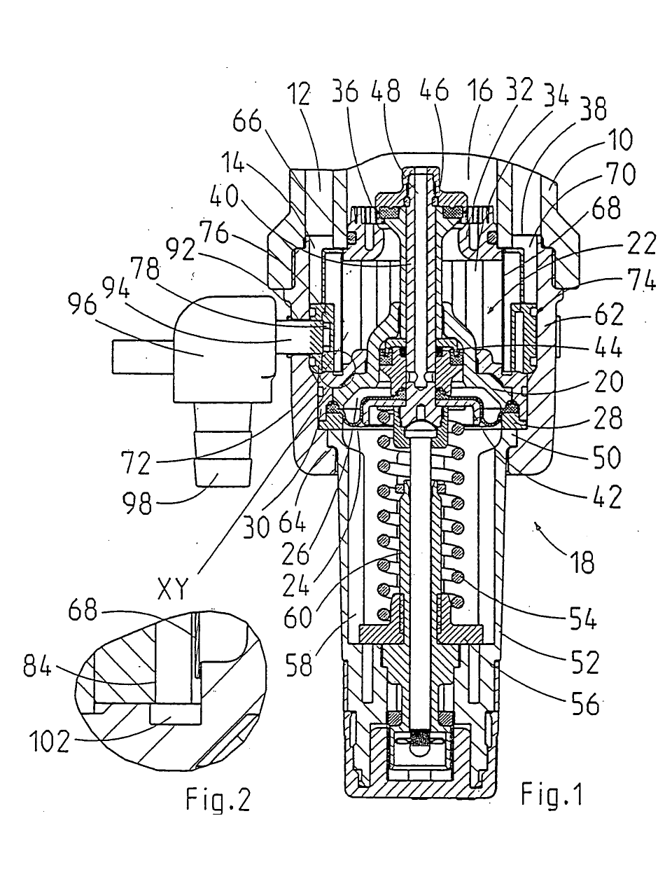

A (partly broken away) housing of a fitting is designated by numeral 10 in FIG. 1. In the simplest case the housing of the fitting 10 has an inlet socket connected to an inlet pressure chamber 14 through an outer annular passage 12 and an outlet socket connected to a central outlet chamber 16. A pressure reducer assembly generally designated by numeral 18 is fixed to the housing of the fitting 10.

The pressure reducer assembly 18 comprises a pressure reducer bottom part 20 and a pressure reducer top part 22. The wording “bottom part” and “top part” refers to the arrangement in FIG. 1 where part 20 is arranged at the bottom and 22 is at the top. The pressure reducer bottom part 20 is cup-shaped and tapering towards the top in FIG. 1. The pressure reducer bottom part 20 is closed by a control diaphragm 24 and forms a control pressure chamber 26. A clamping ring 28 lies on the edge on the control diaphragm 24 and tightens it. The pressure reducer top part 22 is screwed onto the pressure reducer bottom part 20. The pressure reducer top part 22 has a first annular portion 30 and a second annular portion 32. The first annular portion 30 is screwed to the pressure reducer bottom part 20. The second annular portion 32 is connected to the first annular portion 30 through webs 34. The second annular portion 32 forms a valve seat 36 with a valve passage 38 on the side remote from the pressure reducer bottom part 20. A valve tappet 40 is connected to a diaphragm plate 42 of the control diaphragm 24. The valve tappet 40 is guided through the “bottom” of the cup-shaped pressure reducer bottom part 20 with a seal 44 and extends through the valve passage 38. The valve tappet 40, at its end, carries a valve closing body 46 cooperating with the valve seat 36 to form the control valve of the pressure reducer. A passage 48 extends through the valve closing body 46 and the valve tappet 40 transferring the outlet pressure from the control valve downstream to the control pressure chamber 26.

On the pressure ring 28 sits a cap-like spring housing 52 provided with an outer rim 50. The spring housing 52 contains a biased helical spring 54. The helical spring 54 abuts the diaphragm plate 42 of the control diaphragm 24. The helical spring 54 is supported by an adjustable spring abutment 56. The spring abutment is non-rotatably guided by guides 58 in the spring housing and sits on a threaded adjustment spindle 60. By rotating the adjustment spindle 60 the spring abutment 56 can be adjusted. Thereby the bias of the helical spring 54 and thereby the controlled outlet pressure is changed.

A plastic cap 62 of generally cylindrical shape extends around the outer rim 50 of the spring housing 52 with a rim 64 projecting towards the inside. The plastic cap 62 is screwed into the housing of the fitting 10 on the outside of the annular passage 12. Thereby the spring housing 52, the pressure reducer bottom part 20 and the pressure reducer top part 22 are tightened to the housing of the fitting 10. The second annular portion 32 of the pressure reducer top part 22 then tightly sits in the central outlet chamber 16. The sealing against the inner wall of the outlet chamber 16 is achieved by a sealing ring 66.

A cylindrical dirt trap 68 in the form of a sieve or a filter is located between the first annular portion 30 and the second annular portion 32 of the pressure reducer top part 22. The dirt trap 68 divides the inlet pressure chamber 14 into an inlet-side sub-chamber 70 and a control valve-side sub-chamber 72.

This is essentially the construction of a known pressure reducer as described above referring to the prior art.

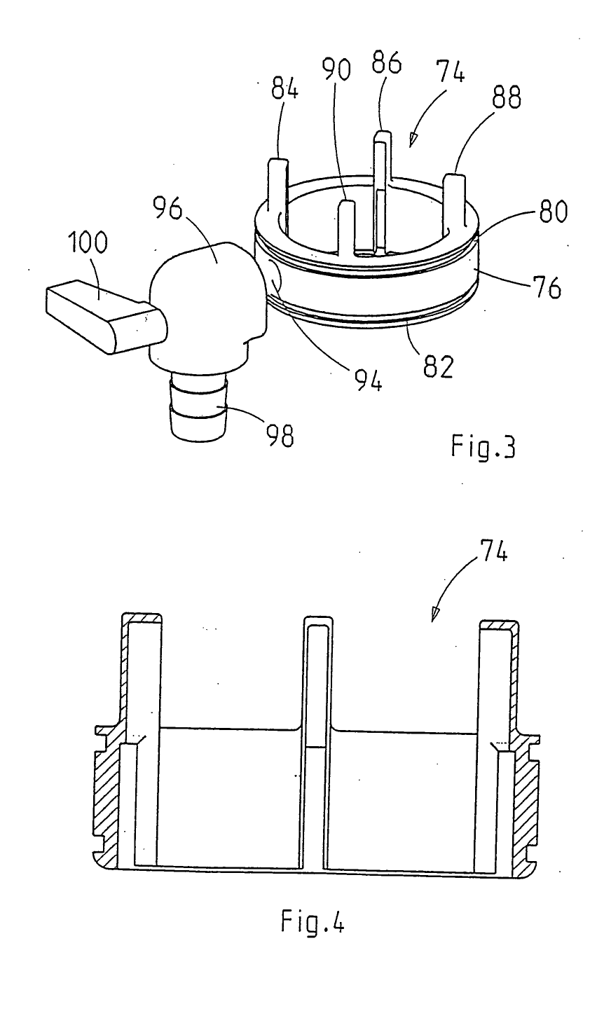

The pressure reducer is provided with backflow means for generating a back flow through the dirt trap 68 from the control valve-side sub-chamber 72 into the inlet-side sub-chamber 70. The backflow means are generally designated by numeral 74 and shown in greater detail in FIGS. 3 and 4. These backflow means permit, from time to time, sucking away the dirt withheld by the dirt trap 68 and discharging it to an outlet.

The backflow means 74 comprise an annular body 76 with an annular chamber 78. The annular body 76, on its outside, carries sealing rings 80 and 82 extending along the circumference and axially spaced from each other. Such sealing rings 80 and 82 engage the inner wall of the plastic cap 62, which forms a portion of the housing of the pressure reducer. Axially projecting sucking ribs 84, 86, 88, 90 are provided on the annular body adjacent to the dirt trap 68 and are open downwards and towards the dirt trap and which are connected to the annular chamber 78 of the annular body 76. The sucking ribs 84, 86, 88, 90 are angularly offset by 90°. A dirt trap 68 lies almost free in an angular range of almost 90° between the sucking ribs 84, 86, 88, 90 which extend only over a small angular range, so that the water can flow through the dirt trap 68 from the inlet-side sub-chamber 70 into the control valve-side sub-chamber 72.

A circumferential slot 92 is provided in the plastic cap 62 between the sealing rings 80 and 82. The circumferential slot 92 extends over an angular range of a little more than 90°. A pipe 94 is guided through the circumferential slot and is affixed to the annular body 76 and ends in the annular chamber 78. The pipe 94 is connected to a stop valve 96. The stop valve 96 controls the connection between the pipe 94 and the outlet socket 98. The stop valve 96, preferably a ball valve, is rotatable between a closing position and an open position by means of a handle 100. In the open position, the annular chamber 78 is connected to atmosphere through the pipe 94 and the outlet socket 98. The water flows from the control valve-side sub-chamber 72 which is essentially under inlet pressure in the direction of the backflow through the dirt trap 68 into the sucking ribs 84, 86, 88, 90 and through the annular chamber 78, the pipe 94 and the outlet socket 98 towards the outlet. Dirt particles which are in normal operation held back on the outside of the dirt trap 68 are then exposed to the backflow and discharged. At the stop valve 96 the annular body 76 can be manually turned by 90° about the dirt trap. In this case the four sucking ribs 84, 86, 88, 90 sweep over the entire surface of the dirt trap 68.

The sucking ribs 84, 86, 88, 90 surround the dirt trap with small tolerance. Larger dirt particles are, therefore, not directly sucked off by the sucking ribs but scraped off the outside of the dirt trap 68. Then they sink down and would only be shifted back and forth when the annular body 76 is rotated. Therefore a ring of blind holes 102 is formed around the outside of the dirt trap 68 in the first annular portion 30 of the pressure reducer top part 22, which can be seen best from the detail XY in FIG. 2. The sunken particles are “swept” into these blind holes 102 by the outsides of the sucking ribs. During the next passage of a sucking rib 84, 86, 88 or 90, respectively, the particles are also sucked in and discharged through the open lower end of the sucking ribs 84, 86, 88, 90.

Whereas the invention is here illustrated and described with reference to an embodiment thereof presently contemplated as the best mode of carrying out the invention in actual practice, it is to be understood that various changes may be made in adapting the invention to different embodiments without departing from the broader inventive concepts disclosed herein and comprehended by the claims that follow.

I claim:

1. A pressure reducer comprising: a housing structure defining an inlet pressure chamber and an outlet pressure chamber, pressure controlled control valve means governing a passage between said inlet pressure chamber and said outlet pressure chamber to provide a reduced outlet pressure in said outlet pressure chamber, cylindrical dirt trap means defining an axis and dividing said inlet pressure chamber into an inlet-side sub-chamber and a control valve-side sub-chamber, and backflow means in said inlet side sub-chamber adjacent to said dirt trap means for generating a backflow through said dirt trap means to flush accumulated dirt thererefrom, wherein said backflow means cover limited angular ranges of said dirt trap means and are rotatable about said axis of said dirt trap means to cover the entire circumference of said dirt trap means.

2. A pressure reducer according to claim 1, wherein
(a) said backflow means have an annular body defining an annular chamber therein, said annular body, on its outside, being sealingly guided in said housing structure by two spaced apart sealing rings which surround said dirt trap,
(b) said annular body is provided with axially projecting sucking ribs adjacent to said dirt trap means and defining a chamber open towards said dirt trap means, said chamber being connected to said annular chamber of said annular body,
(c) said annular body is rotatable about said dirt trap means and
(d) means are provided for generating, in said annular chamber, a pressure which is reduced with respect to the inlet pressure.

3. A pressure reducer according to claim 2, wherein
(a) a circumferencial slot is provided in said housing structure around said annular body, said slot extending through an angular range and being sealed against the annular body by sealing rings, which engage said housing structure on both sides of said circumferential slot,
(b) an outlet pipe guided through said circumferential slot and affixed to said annular body and
(c) an stop valve is positioned in said outlet pipe and governs communication between said outlet pipe and an outlet socket.

4. A pressure reducer according to claim 3, wherein said sucking ribs are open axially downwards and a circular array of axial blind holes is formed there around said dirt trap means.

5. A pressure reducer according to claim 4, wherein
(a) a cup-shaped pressure reducer bottom part is closed by a spring biased control diaphragm and defines a control pressure chamber exposed to said outlet pressure,
(b) a pressure reducer top part in alignment therewith is provided with a first annular portion, which is fixed to said pressure reducer bottom part and which is connected to a second annular portion by webs, said second annular portion forming a valve seat with a valve passage of said control valve,
(c) a valve tappet is connected to said control diaphragm, said valve tappet extending through said control pressure chamber, said pressure reducer bottom part and said valve passage and carrying a valve closing member, which, together with said valve seat, forms said control valve and
(d) said dirt trap is held coaxial to said valve tappet between said first annular portion and said second annular portion.

6. A pressure reducer according to claim 5, wherein
(a) a spring housing containing the biasing spring, said pressure reducer bottom part and said pressure reducer top part are sealed by tightening said control diaphragm against said housing structure by means of a fixing cap screwed to said housing structure, said inlet pressure chamber being defined within said fixing cap, and
(b) said slot for the outlet pipe is provided in said fixing cap.

7. A pressure reducer according to claim 3, wherein
(a) a cup-shaped pressure reducer bottom part is closed by a spring biased control diaphragm and defines a control pressure chamber exposed to said outlet pressure,
(b) a pressure reducer top part in alignment therewith is provided with a first annular portion, which is fixed to said pressure reducer bottom part and which is connected to a second annular portion by webs, said second annular portion forming a valve seat with a valve passage of said control valve,
(c) a valve tappet is connected to said control diaphragm, said valve tappet extending through said control pressure chamber, said pressure reducer bottom part and said valve passage and carrying a valve closing member, which, together with said valve seat, forms said control valve and
(d) said dirt trap is held coaxial to said valve tappet between said first annular portion and said second annular portion.

8. A pressure reducer according to claim 7, wherein
(a) a spring housing containing the biasing spring, said pressure reducer bottom part and said pressure reducer top part are sealed by tightening said control diaphragm against said housing structure by means of a fixing cap screwed to said housing structure, said inlet pressure chamber being defined within said fixing cap, and
(b) said slot for the outlet pipe is provided in said fixing cap.
